(19) United States
(12) Patent Application Publication
(10) Pub. No.: US 2016/0240845 A1
(43) Pub. Date: Aug. 18, 2016

(54) ELECTRICAL STORAGE DEVICE INCLUDING ANODE AND CATHODE

(71) Applicant: Panasonic Intellectual Property Management Co., Ltd., Osaka (JP)

(72) Inventors: NORIHITO FUJINOKI, Osaka (JP); HARUHIKO HABUTA, Osaka (JP)

(21) Appl. No.: 14/995,856

(22) Filed: Jan. 14, 2016

(30) Foreign Application Priority Data
Feb. 18, 2015 (JP) 2015-029393
Sep. 18, 2015 (JP) 2015-184550

(51) Int. Cl. H01M 4/48; H01M 4/04; H01M 10/0525; H01M 4/66; H01M 2/16

(52) U.S. Cl. CPC H01M 4/48; H01M 4/661; H01M 2/1646; H01M 10/0525; H01M 4/0404; H01M 2220/30; H01M 2220/20

(57) ABSTRACT

An electrical storage device includes: a conductive anode collector; a conductive cathode collector; an anode between the anode collector and the cathode collector, the anode containing a mixture of an insulating material and an oxide of cerium; and a cathode between the cathode collector and the anode.

### BACKGROUND

1. Technical Field

The present disclosure relates to an electrical storage device and a method for producing the same.

2. Description of the Related Art

The recent rapidly increasing use of information and communication devices and the like, such as PCs, video cameras, and mobile phones, has led to increased importance of the development of electrical storage devices for use as a power supply for these devices. Furthermore, automotive and other industries are active in developing high-power and high-capacity batteries for electric or hybrid vehicles. The current focus is on lithium-ion batteries, which provide a higher energy density than other kinds of batteries.

The lithium-ion batteries currently on the market incorporate an electrolytic solution that contains an inflammable organic solvent. Lithium-ion batteries in which an electrolytic solution is used therefore need to be installed with a safety device to control the increase in temperature that occurs in case of a short circuit, and also need improvement in structural and material aspects to prevent short circuits.

A known alternative to the lithium-ion battery is the all-solid-state lithium-ion battery, which is a battery totally solid as a result of replacement of the electrolytic solution with a solid electrolyte layer. Containing no inflammable organic solvent inside, all-solid-state lithium-ion batteries are less likely to leak or explode, therefore requiring a less complicated safety device, and are under active development with the aim of reduced production cost and improved safety and reliability. For example, some researchers have proposed an all-solid-state battery whose structural elements are all solid, including an inflammable solid electrolyte.

Furthermore, a method has been disclosed in which an all-solid-state battery is produced through the firing of a stack of an electrode layer containing an electrode active material and a solid electrolyte layer (for example, see Japanese Unexamined Patent Application Publication No. 2007-5279). There is also a high-performance all-solid-state lithium-ion battery provided through the use of a sheet-shaped anode containing a fibrous carbon material as a conductive agent and a thermoplastic as a binder (for example, see Japanese Unexamined Patent Application Publication No. 2009-146581).

Another form of an all-solid-state battery is also possible. In some methods disclosed in recent years for producing an electrical storage device, the storage device is composed of an electrical storage layer made up of fine particles of a metal oxide semiconductor coated with an insulating material, a p-type semiconductor layer, and electrodes sandwiching these two layers (for example, see International Publication Nos. 2012/046325 and 2013/065093). The electrical storage layer charges by trapping electrons at an energy level created in a band gap of the fine particles of a metal oxide semiconductor, and discharges by releasing the trapped electrons. According to the publications, the metal oxide semiconductor can be, for example, titanium oxide (TiO₂), tin oxide (SnO₂), or zinc oxide (ZnO). No electrolyte layer is required, and the electrical storage layer is formed through the application of a liquid containing a metal oxide semiconductor and an insulating material, making the illustrated structure excellent in terms of size scalability and cost. The illustrated structure is also expected to be advantageous in other ways, such as a high energy density as well as high safety and excellent resistance to environmental conditions resulting from its nature of being an all-solid-state battery.

Japanese Unexamined Patent Application Publication No. 2015-082445 proposes a method for producing an all-solid-state battery whose structural elements are all solid, and in this method an inflammable solid electrolyte is used. The all-solid-state battery disclosed in this publication includes a cathode containing materials including at least one of nickel oxide, nickel hydroxide, lead oxide, and lead sulfate, a solid electrolyte, and an anode made of titanium oxide. This battery charges by releasing protons from the cathode into the solid electrolyte and taking the protons from the solid electrolyte into the anode, and discharges through the opposite reaction. The solid electrolyte is in the form of a porous film, and there are OH groups on the surface of the pores. With these OH groups, the pores are capable of holding water inside, allowing the film to serve as a solid electrolyte.

### SUMMARY

One non-limiting and exemplary embodiment provides an electrical storage device with improved capacity. Another non-limiting and exemplary embodiment provides a method for producing this electrical storage device.

In one general aspect, the techniques disclosed here feature an electrical storage device. The electrical storage device includes a conductive anode collector, a conductive cathode collector, an anode between the anode collector and the cathode collector, and a cathode between the cathode collector and the anode. The anode contains a mixture of an insulating material and an oxide of cerium.

The electrical storage device according to an aspect of the present disclosure provides an electrical storage device that offers improved capacity. The production method according to another aspect provides a method through which this electrical storage device can be produced.

It should be noted that general or specific embodiments may be implemented as a device, a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic cross-sectional view of an electrical storage device according to Embodiment 1;

FIG. 2 is a schematic cross-sectional diagram illustrating the structure of the anode of an electrical storage device according to Embodiment 1;

FIG. 3 is a flow diagram illustrating a method for producing an electrical storage device according to Embodiment 1;

FIG. 4 is a schematic cross-sectional view of an electrical storage device according to Example 1;

FIG. 5 is a schematic cross-sectional view of a variation of an electrical storage device according to Embodiment 1; and

FIG. 6 is a schematic cross-sectional view of another variation of an electrical storage device according to Embodiment 1.

### DETAILED DESCRIPTION

### Underlying Knowledge Forming Basis of the Present Disclosure

To make a high-performance all-solid-state battery, it is needed to develop a solid electrolyte and cathode and anode materials that are all highly conductive at room temperature. It is also needed to overcome problems such as difficulty in forming a good electrode-electrolytic solid interface and giving the batteries a high capacity in a stable manner. The characteristics of an all-solid-state battery may be likely to be affected through repeated charge-discharge cycles. Moreover, the production of the aforementioned materials involves long periods of heat treatment at high temperatures, which can alter the quality of the materials. Because of these factors, it is difficult to produce high-performance all-solid-state batteries.

The inventors found through extensive research that a high-capacity electrical storage device that is simple in structure, therefore capable of low-cost production and stable operation, and a method that provides such an electrical storage device are made possible through the use of an anode containing a mixture of an insulating material and an oxide of cerium. In other words, the inventors found that when an anode as a structural element of an electrical storage device is made of a material containing a mixture of an insulating material and an oxide of cerium, the electrical storage device is of high capacity.

An electrical storage device according to an aspect of the present disclosure includes a conductive anode collector, a conductive cathode collector, an anode between the anode collector and the cathode collector, and a cathode between the cathode collector and the anode. The anode contains a mixture of an insulating material and an oxide of cerium.

The anode collector serves as a first electrode, and the cathode collector serves as a second electrode. The anode serves as an electrical storage layer. The anode is therefore used to store charge.

The oxide of cerium may be in the form of particles. The particles may be dispersed in the insulating material. The size of the particles may be 1 nm or more and 20 nm or less. The arithmetic mean particle diameter of the particles may be 1 nm or more and 100 nm or less, 1 nm or more and 20 nm or less, or 1 nm or more and 10 nm or less.

The arithmetic mean particle diameter in the above paragraph is a measurement obtained using an electron microscope. The arithmetic mean particle diameter of particles of a metal oxide such as the oxide of cerium is herein calculated as follows. First, particles of the metal oxide are observed under an electron microscope (a SEM or TEM). In the obtained image, any 50 primary particles (hereinafter simply referred to as particles) are selected for the calculation of their individual particle diameters a. The particle diameter a of each particle is calculated from its area S in the image using the equation below and averaged for the 50 particles. The obtained arithmetic mean is defined as the arithmetic mean particle diameter of the metal oxide.

a=2×(S/3.14)^{1/2}

The anode may be porous in structure. There may be a solid electrolyte between the anode and the cathode. Alternatively, the anode and the cathode may be in direct contact with each other. This makes the insulating material serve as a solid electrolyte.

The anode collector may be made of at least one metal or an alloy as a combination of metals selected from the group consisting of copper, chromium, nickel, titanium, platinum, gold, aluminum, tungsten, iron, and molybdenum, and so may the cathode collector.

The electrical storage device may further include a substrate in contact with the anode collector on the side opposite the anode. The substrate may be a flexible insulating sheet. Alternatively, the anode collector may double as a substrate.

The cathode may be made of an oxide of nickel or a copper aluminum oxide. The cathode may be made of a p-type semiconductor material.

The insulating material may include at least one selected from the group consisting of silicone, silicon dioxide, magnesium oxide, alumina, and mineral oil. The insulating material may be silicone. The insulating material may include at least one selected from the group consisting of thermoplastics such as polyethylene, polypropylene, polystyrene, polybutadiene, polyvinyl chloride, polymethyl methacrylate, polyamide, polycarbonate, polyimide, and cellulose acetate, phenolic plastics, amino plastics, unsaturated polyester plastics, allyl plastics, alkyd plastics, epoxy plastics, and polyurethanes.

A method according to an aspect of the present disclosure for producing an electrical storage device includes preparing an anode collector, producing a coating liquid by dissolving particles of an oxide of cerium and an insulating material in an organic solvent, applying the coating liquid to the anode collector to form a coating film, firing the coating film to form an anode, forming a cathode on the anode, and forming a cathode collector on the cathode.

The anode collector serves as a first electrode, and the cathode collector serves as a second electrode. The anode serves as an electrical storage layer. The anode is therefore used to store charge.

The coating film may be fired at a temperature of 200° C. to 500° C. to form a dispersion of the particles of the oxide of cerium in the insulating material.

The cathode may be formed from an oxide of nickel or a copper aluminum oxide. The cathode may be made of a p-type semiconductor material.

The following describes some embodiments of the electrical storage device according to an aspect of the present disclosure and the method according to another aspect for producing this electrical storage device.

### Embodiment 1

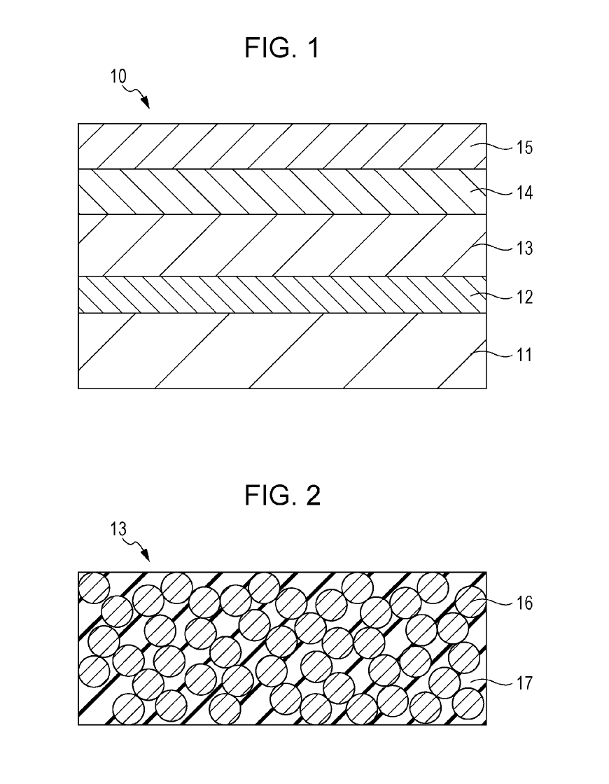

An electrical storage device 10 according to Embodiment 1 includes, as illustrated in FIG. 1, a conductive anode collector 12, an anode 13, a cathode 14, and a conductive cathode collector 15. In FIG. 1, the anode collector 12 is on a substrate 11. The conductive anode collector 12, the anode 13, the cathode 14, and the conductive cathode collector 15 are stacked in this order in the electrical storage device 10. The expression “stacked in this order” includes cases where the layers are stacked in the reverse order, i.e., the conductive cathode collector 15, the cathode 14, the anode 13, and then the conductive anode collector 12. There may optionally be one or more intermediate layers each located between any two adjacent layers to provide a desired function. Examples of intermediate layers that can be used include a diffusion barrier layer that prevents the diffusion of impurities from the collectors and an electron injection layer that helps electrons to be effectively transferred from a collector to the anode or the cathode. The electrical storage device 10 may include a solid electrolyte 50 between the anode 13 and the cathode 14 (see FIG. 5). The solid electrolyte 50 can be, for example, a 5-nm-thick layer of silicon oxide (SiO₂).

The anode 13 is a composite in which a metal oxide and an insulating material are mixed. The anode 13 may be in the form of a thin film. The metal oxide includes an oxide of cerium. In general, oxides of cerium are n-type semiconductor materials. In this embodiment, the oxide of cerium is, for example, CeO₂. Any other oxide of cerium can also be used as long as the anode 13 is capable of charge and discharge, including oxides of cerium with off-stoichiometric compositions. It is desirable that the anode 13 be, as illustrated in FIG. 2, a substantially uniform dispersion of fine particles of a metal oxide 16 in an insulating material 17. It is desirable that the size of the particles be 1 nm or more and 20 nm or less, more desirably 6 nm or less. Moreover, it is desirable that the anode 13 be porous in structure, desirably with OH groups on the surface of the pores to help water to be held. Making the anode 13 porous in structure with OH groups on the surface of the pores to help water to be held in the pores improves the transfer of ions.

The thickness of the anode 13 is in the range of, for example, 50 nm to 10 μm, desirably 100 nm to 5 μm, more desirably 200 nm to 2 μm.

The cathode 14 is made of, for example, a transition metal oxide, such as an oxide of nickel (NiO) or a copper aluminum oxide (CuAlO₂). It is desirable that the cathode 14 be made of a material that is more easily reduced than the metal oxide 16 in the anode 13.

The substrate 11 as a structural element of the electrical storage device 10 according to this embodiment may be insulating or conductive. The substrate 11 may be rigid or flexible. The substrate 11 may be a flexible sheet. This makes the electrical storage device 10 usable on a curved surface and in applications where the device may be folded. The substrate 11 may be of any kind that is not altered when a layer of inorganic or organic substance is formed thereon. The substrate 11 can be, for example, a glass substrate, a plastic substrate, a polymer film, a silicon substrate, a metal plate, a sheet of metallic foil, or a multilayer stack of these. The substrate 11 may be a commercially available substrate or a substrate produced using a known method.

The anode collector 12 and the cathode collector 15 as structural elements of the electrical storage device 10 according to this embodiment may be of any kind that is conductive. The anode collector 12 and the cathode collector 15 are made of, for example, metal. Examples of metals that can be used include those containing at least one metal element selected from the group consisting of copper (Cu), chromium (Cr), nickel (Ni), titanium (Ti), platinum (Pt), gold (Au), aluminum (Al), tungsten (N), iron (Fe), and molybdenum (Mo) and alloys as a combination of any of these metal elements.

The anode collector 12 and the cathode collector 15, both conductive, can be transparent. Examples of transparent conductive collectors that can be used include, but are not limited to, conductive films made of indium tin oxide (ITO), indium zinc oxide (IZO), fluorine-doped tin oxide (FTO), antimony-doped tin oxide (ATO), indium oxide (In₂O₃), tin oxide (SnO₂), Al-containing ZnO, or similar.

Each collector can be a multilayer film including two or more of such metallic or transparent conductive films, unless the performance of the electrical storage device 10 is affected.

It is desirable that the insulating material 17 be a heat-resistant insulating material, such as an inorganic insulating material or an insulating plastic. Examples of inorganic insulating materials that can be used include silicone, silicon dioxide (SiO₂), magnesium oxide (MgO), alumina (Al₂O₃), and mineral oil. For insulating plastics, examples include thermoplastics such as polyethylene, polypropylene, polystyrene, polybutadiene, polyvinyl chloride, polymethyl methacrylate, polyamide, polycarbonate, polyimide, and cellulose acetate, as well as thermosetting plastics such as phenolic plastics, amino plastics, unsaturated polyester plastics, allyl plastics, alkyd plastics, epoxy plastics, and polyurethanes. Silicone is particularly desirable.

If a solid electrolyte is placed between the anode 13 and the cathode 14, the solid electrolyte can be made of any material that forms a solid acid or a solid base. It is desirable that the solid electrolyte be made of an inorganic oxide. Examples include silicon oxide, tantalum oxide, tungsten oxide, niobium oxide, zirconium oxide, hafnium oxide, aluminum oxide, magnesium oxide, and zinc oxide, and silicon oxide is desirable to the others. It is, furthermore, desirable that the solid electrolyte be porous in structure. A porous solid electrolyte has OH groups on the surface of its pores, and these OH groups help water to be held. As a result, the transfer of ions is improved. Besides the insulating oxides listed above, insulating polymer materials can also be used.

The mechanism by which the electrical storage device 10 according to this embodiment stores electricity is not completely clear, but the inventors speculate as follows.

When negative and positive voltages are applied to the anode collector 12 and the cathode collector 15, respectively, using a power supply (not illustrated) connected across the anode collector 12 and the cathode collector 15, the metal oxide 16 as a structural element of the anode 13 is supplied with electrons via the anode collector 12 and positively charged ions from the cathode 14, and this results in the metal oxide 16 being reduced and the cathode 14 being oxidized. The insulating material 17 is usually selected from nonconductors for electrons and good conductors for ions. To be more specific, the insulating material 17 is selected from substances that allow protons (H⁺) and hydroxy ions (OH⁻) to freely pass through. Even after the application of voltages is stopped, therefore, the metal oxide 16 and the cathode 14 remain in the reduced and oxidized states, respectively, because the electrons that have moved to the metal oxide 16 are shielded by the insulating material 17. This is the charged state, and in this state the electrical storage device 10 is able to perform its function as a storage device.

When discharged via a load connected to the anode collector 12 and the cathode collector 15, the electrical storage device 10 returns to its initial state through the reaction opposite the above charging reaction. That is, the reduced metal oxide 16 releases electrons via the anode collector 12, and the cathode 14 is supplied with positively charged ions. As a result, the reduced metal oxide 16 is oxidized, and the cathode 14 is reduced. This is the state in which the device emits energy, the discharging state.

The hydroxy groups (OH groups) existing on the surface of or in the boundaries between particles of the metal oxide 16 in the anode seem to improve the ionic conductivity of the anode.

In the opinion of the inventors, therefore, the metal oxide 16 as a structural element of the anode 13 and the cathode 14 undergo what is called electrochemical redox reaction, and this reaction enables the electrical storage device 10 to perform its function as a storage device. This phenomenon is repeatable.

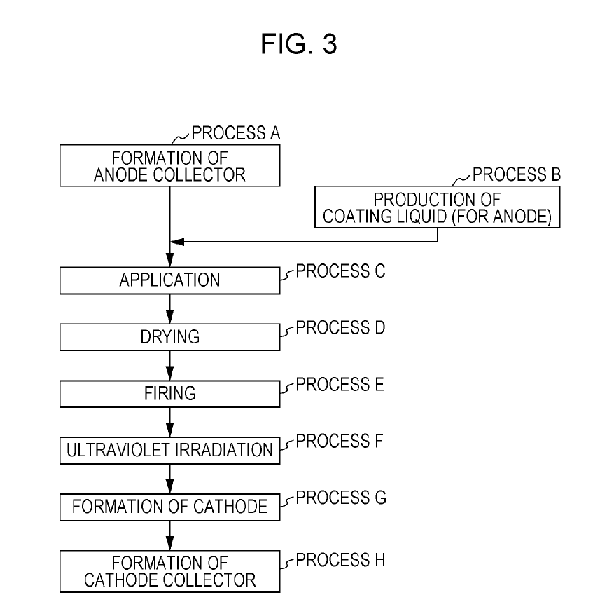

Referring to FIG. 3, the following describes a method for producing the electrical storage device 10 illustrated in FIG. 1. FIG. 3 is a flow diagram for the production of the electrical storage device.

### Process A

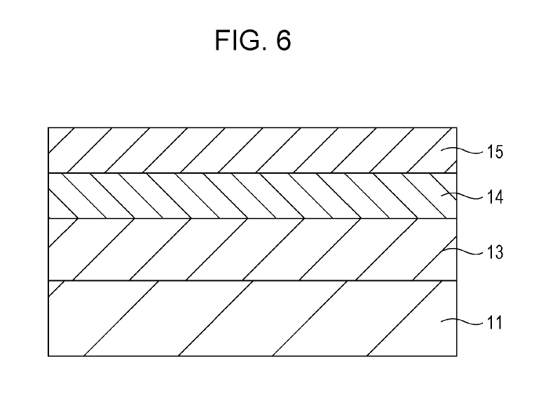

A conductive anode collector 12 is formed on a substrate 11 through sputtering or similar. If the substrate 11 is conductive and doubles as the anode collector 12, process A can be omitted. Without process A, the electrical storage device 10 will be composed of a substrate 11, an anode 13, a cathode 14, and a conductive cathode collector 15 as illustrated in FIG. 6.

Thin-film formation methods, such as chemical deposition and physical deposition, can be used to form the conductive anode collector 12. Examples of physical deposition techniques that can be used include sputtering, vacuum deposition, ion plating, and PLD, a technique in which pulsed laser is directed to a target material to be deposited. Examples of chemical deposition techniques that can be used include chemical vapor deposition (CVD), such as plasma CVD, thermal CVD, and laser CVD, liquid-phase deposition, such as electrolytic plating, immersion plating, electroless plating, and other wet plating techniques, the sol-gel process, MOD, spray pyrolysis deposition, as well as printing of a liquid dispersion of fine particles using techniques such as doctor blading, spin coating, inkjet printing, and screen printing. It is desirable that the conductive anode collector 12 be formed using any of sputtering, vacuum deposition, PLD, and CVD, but the methods that can be used are not limited to these.

### Process B

In process B, a coating liquid for the formation of an anode 13 is produced. The coating liquid can be a solution of an organic acid-metal salt or a liquid dispersion of nanoparticles. The solution of an organic acid-metal salt is prepared by, for example, dissolving the organic acid-metal salt (i.e. a salt formed by a metal and an organic acid) and an insulating material in a solvent. The liquid dispersion of nanoparticles is prepared by mixing a metal oxide in the form of particles, an insulating material, and a solvent.

The liquid dispersion of nanoparticles contains a metal oxide in the form of particles. To be more specific, the liquid dispersion of nanoparticles as the coating liquid can be prepared by mixing particles of an oxide of cerium, an insulating material, and a solvent. The particle diameter of the particles of the metal oxide 16 can be 100 nm or less, and can also be 10 nm or less. The particle diameter of the particles of the metal oxide 16 can also be 20 nm or less. In light of the fact that the surface area per unit volume of particles increases with decreasing particle diameter, smaller particle diameters are more advantageous in increasing the capacity of the electrical storage device 10. For higher dispersibility in the insulating material and the solvent, the metal oxide in the form of particles may be subjected to pretreatment or preliminary treatment with a dispersant or a surfactant. The dispersant can be a silane coupling agent or similar. Not limited to silane coupling agents, the dispersant can also be any other material unless the characteristics of the electrical storage device 10 are significantly affected. The particle diameter of the particles of the metal oxide 16 can be 1 nm or more.

The organic acid-metal salt is at least one organic metal-acid salt selected from those aliphatic acid- and aromatic acid-metal salts that are capable of decomposing or burning into metal oxides when ultraviolet-irradiated or fired in an oxidizing atmosphere. An example of a method for formation is as follows. First, an aliphatic acid-metal salt and an insulating material are dissolved in an organic solvent, producing a coating liquid. Then this coating liquid is applied to, for example, the anode collector to form a coating film. The coating film is then fired and ultraviolet-irradiated. The aliphatic acid-metal salt is of a kind that is able to turn into a metal oxide through this process of dissolution, application, firing, and ultraviolet irradiation. The aliphatic acid can be, for example, an aliphatic monocarboxylic acid or an aliphatic polycarboxylic acid, such as an aliphatic dicarboxylic, tricarboxylic, or tetracarboxylic acid.

Specific examples of aliphatic monocarboxylic acids that can be used include formic acid, acetic acid, propionic acid, caproic acid, heptanoic acid, hexanoic acid, nonanoic acid, enanthic acid, caprylic acid, pelargonic acid, capric acid, stearic acid, butenoic acid, crotonic acid, isocrotonic acid, linolenic acid, and oleic acid.

It is desirable that the aliphatic acid-metal salt be a salt of an aliphatic acid having a linear alkyl group and a metal. It is because such an aliphatic acid easily decomposes or burns when heated, is highly soluble in solvents, forms a dense film after decomposition or burning, is easy to handle and inexpensive, and can be easily synthesized with a metal into a salt. Carboxylic acids having a branched alkyl group, such as 2-ethyl hexanoic acid, for example, are commonly used because they are liquid at room temperature and highly soluble in solvents. However, the use of a salt of a carboxylic acid having a branched alkyl group, typically 2-ethyl hexanoic acid, often leads to the coating film shrinking and cracking upon being fired. With such a salt, furthermore, the density of the resulting film is low, and it is difficult to obtain uniform film characteristics. It is therefore desirable that the carboxylic acid be of a kind that has a linear alkyl group, rather than a branched, bulky one.

If an aromatic carboxylic acid is used, aromatic monocarboxylic and polycarboxylic acids are usable. Examples of aromatic polycarboxylic acids that can be used include aromatic dicarboxylic, tricarboxylic, and tetracarboxylic acids as well as mixtures of these. Examples of aromatic monocarboxylic acids that can be used include benzoic acid, salicylic acid, cinnamic acid, gallic acid, and mixtures of these. Examples of aromatic dicarboxylic acids that can be used include phthalic acid, isophthalic acid, terephthalic acid, and mixtures of these. Examples of aromatic tricarboxylic acids that can be used include trimellitic acid. Examples of aromatic tetracarboxylic acids that can be used include pyromellitic acid. Examples of aromatic hexacarboxylic acids that can be used include mellitic acid. A salt of any of these aromatic acids and a metal can be used alone, and it is also possible to use a mixture of two or more aromatic acid-metal salts.

The solvent can be any material in which the aliphatic acid-metal salt to be used is sufficiently soluble. Examples of desirable solvents include hydrocarbons, alcohols, esters, ethers, and ketones, such as ethanol, xylene, toluene, butanol, acetyl acetone, ethyl acetoacetate, and methyl acetoacetate.

Processes A and B can be performed in this order or in the reverse order, and can even be parallel processes.

### Process C

Then using spin coating or similar, the coating liquid is applied to the anode collector 12 to form a coating film. For example, if spin coating is used to form the coating film, a spinner is operated to spin-coat the anode collector 12 on the substrate 11 with the coating liquid while the substrate 11 is rotated. The rotation of the substrate 11 produces a thin layer of 0.3 to 3 μm.

Various methods can be used to make the coating liquid into a film. Examples include coating techniques such as spin coating, casting, gravure coating, bar coating, roller coating, wire bar coating, dip coating, slit coating, capillary coating, spray coating, and nozzle coating and printing techniques such as gravure printing, screen printing, flexographic printing, offset printing, reverse printing, and inkjet printing.

### Process D

Then the anode collector 12 on which the coating film has been formed is dried by allowing it to stand in an atmosphere at 50° C. for approximately 10 minutes. Process D may be omitted if the coating liquid is highly volatile.

### Process E

The dried article is then fired at a temperature of 200° C. to 500° C. for approximately 10 minutes to 1 hour. The firing produces a layer including the insulating material 17 as a matrix and fine particles of the metal oxide 16 dispersed in the matrix insulating material 17.

### Process F

The coating film which has gone through processes D and E is then irradiated with ultraviolet light. The parameters for the ultraviolet irradiation are, for example, a wavelength of 254 nm, an intensity of 100 mW/cm², and a duration of approximately 30 to 240 minutes. Process F may be omitted if the organic acid-metal salt and the insulating material in the coating film have been fully decomposed and fired in process E.

The ultraviolet irradiation can be performed using a method such as a high-pressure or low-pressure mercury lamp or a YAG laser, desirably through a high irradiation energy density process because such a process makes the take time in production shorter.

These operations for processes D, E, and F may be repeated multiple times to adjust the thickness of the anode 13, if necessary.

### Process G

A cathode 14 is then formed on the anode 13 using sputtering or similar. Thin-film formation methods, such as chemical deposition or physical deposition, can be used to form the cathode 14. Examples of physical deposition techniques that can be used include sputtering, vacuum deposition, ion plating, and PLD, a technique in which pulsed laser is directed to a target material to be deposited. Examples of chemical deposition techniques that can be used include chemical vapor deposition (CVD), such as plasma CVD, thermal CVD, and laser CVD, liquid-phase deposition, such as electrolytic plating, immersion plating, electroless plating, and other wet plating techniques, the sol-gel process, MOD, spray pyrolysis deposition, as well as printing of a liquid dispersion of fine particles using techniques such as doctor blading, spin coating, inkjet printing, and screen printing. It is desirable that the cathode 14 be formed using any of sputtering, vacuum deposition, PLD, and CVD, but the methods that can be used are not limited to these.

### Process H

Lastly, a conductive cathode collector 15 is formed. The cathode collector 15 can be formed using the same method as in the formation of the anode collector 12 (process A). Through these processes, an electrical storage device 10 is produced.

If a solid electrolyte is formed between the anode 13 and the cathode 14, the process described below follows process F. A solid electrolyte is formed on the anode 13 using sputtering or similar. Thin-film formation methods, such as chemical deposition and physical deposition, can be used to form the solid electrolyte. Examples of physical deposition techniques that can be used include sputtering, vacuum deposition, ion plating, and PLD, a technique in which pulsed laser is directed to a target material to be deposited. Examples of chemical deposition techniques that can be used include chemical vapor deposition (CVD), such as plasma CVD, thermal CVD, and laser CVD, liquid-phase deposition, such as electrolytic plating, immersion plating, electroless plating, and other wet plating techniques, the sol-gel process, MOD, spray pyrolysis deposition, as well as printing of a liquid dispersion of fine particles using techniques such as doctor blading, spin coating, inkjet printing, and screen printing. It is desirable that the solid electrolyte be formed using any of sputtering, vacuum deposition, PLD, and CVD, but the methods that can be used are not limited to these. After this process, the cathode 14 is formed on the solid electrolyte through process G described above.

Although rectangular in Examples below, the top-view shape of an electrical storage device 10 according to the present disclosure need not be a rectangle, and can also be a circle, an oval, a hexagon, and so forth. As for the structure of the electrical storage device 10, various structures such as a multilayer or folded structure can be selected according to the shape and use of the device. The electrical storage device 10 can also be in any desired shape, such as a cylinder, a prism, or a button-like, coin-like, or other flat shape. The structures and shapes that can be chosen are not limited to these.

The foregoing description is of a case where an anode collector 12 is formed first and a cathode collector 15 lastly. In the opposite case, i.e., if a cathode collector 15 is the first and the anode collector 12 is the last, the order of processes is simply reversed, and the details of each process are the same as described above.

### EXAMPLES

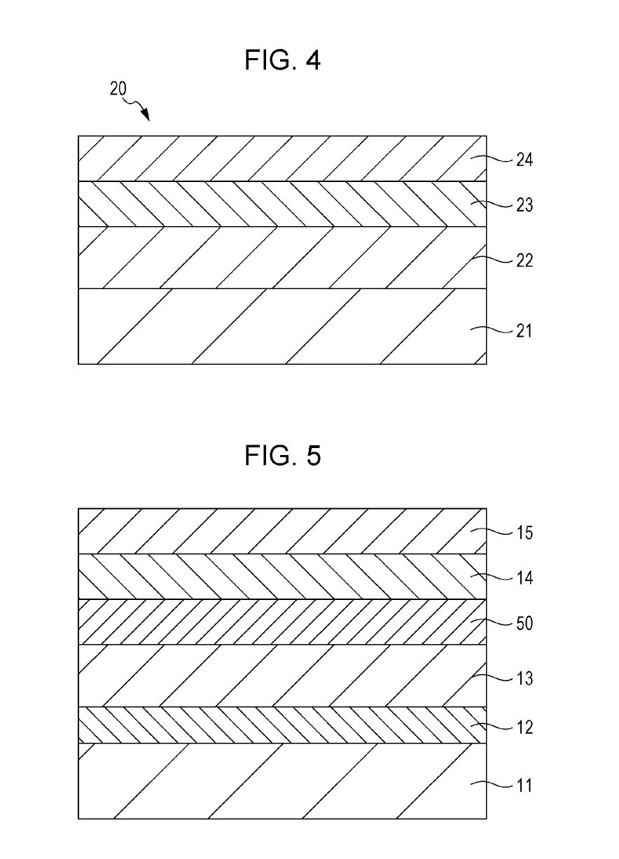

The following describes the present disclosure on the basis of examples, referring to FIG. 4. These examples do not limit any aspect of the present disclosure.

### Example 1

FIG. 4 is a schematic cross-sectional diagram illustrating the structure of an electrical storage device 20 according to Example 1.

The electrical storage device 20 illustrated in FIG. 4 was produced using a stainless steel plate measuring 3 cm by 3 cm and 0.5 mm thick as a substrate 21. With no separate anode collector formed, the stainless steel substrate doubled as the collector.

The anode 22 was formed as follows. First, a coating liquid was prepared by dispersing particles of an oxide of cerium in an adequate amount of ethyl acetate and stirring the dispersion with silicone oil. A spinner was operated (2000 rpm, 10 sec) to spin-coat the substrate 21 with the coating liquid, which was then dried on a hot plate at approximately 50° C. for 10 minutes under atmospheric conditions. The dried coating was then fired at approximately 500° C. for 60 minutes, forming a hybrid film containing the oxide of cerium and an oxide of silicon. This hybrid film was then ultraviolet-irradiated using a low-pressure mercury lamp, completing the anode 22. The parameters for irradiation were a wavelength of 254 nm, approximately 80 mW/cm², and 120 minutes.

After the formation of the anode 22, a 300-nm-thick layer of nickel oxide (NiO) as the cathode 23 was formed on the anode 22 using a radiofrequency magnetron sputtering system in combination with a shadow mask having a size of 2 cm by 2 cm. A 150-nm-thick layer of tungsten (W) as the cathode collector 24 was then formed on the cathode 23 using the same method, completing the electrical storage device 20. The area available for driving of the produced electrical storage device 20 was 4 cm².

The charge-discharge characteristics of the electrical storage device 20 of Example 1 produced as above were evaluated. In a constant-current charge-discharge test for charge-discharge measurement, the device was charged at a constant voltage of 2 V for 5 minutes, and then discharged at 25° C. with the discharge current density and the discharge cutoff voltage set to be 12.5 μA/cm² and 0 V, respectively. This constant-current charge-discharge test was performed using Solartron 1470E charge-discharge test system. As presented in Table 1, the discharge capacity of the electrical storage device based on the results of this charge-discharge measurement was 144 nWh/cm².

### Comparative Example 1

An electrical storage device was produced through the same processes as in Example 1 except that the metal oxide was an oxide of titanium in the form of fine particles. Charge-discharge measurement was performed in the same way as in Example 1. As presented in Table 1, the discharge capacity was 56 nWh/cm², lower than that of the electrical storage device in which the metal oxide was an oxide of cerium.

TABLE 1

| | Discharge capacity (nWh/cm²) |
|---|---|
| Example 1 | 144 |
| Comparative Example 1 | 56 |

### Example 2

The ionic conductivity of anodes according to Example 1 and Comparative Example 1 was evaluated. Anodes according to Example 1 and Comparative Example 1 were produced on respective quartz substrates with 3-mm wide and 1-mm pitch rectangular electrodes thereon, producing ionic conductivity test samples. After being allowed to stand at room temperature and 50% relative humidity for 1 hour, the ionic conductivity test samples were measured using an electrochemical system (Modulab). The proton conductivity at 25° C. of each sample was calculated using an impedance plot (Nyquist plot) created through an alternating-current impedance measurement over a frequency range of 0.1 Hz to 1 MHz with an AC bias of a 200 mV amplitude. The results are summarized in Table 2. As is clear from Table 2, the anode described in Example 1, in which the metal oxide in the anode 22 was an oxide of cerium, had higher ionic conductivity than that in Comparative Example 1, in which the metal oxide was an oxide of titanium. An electrical storage device in which the metal oxide in the anode 22 is an oxide of cerium therefore offers high capacity, good cycle characteristics, and good characteristics in quick charge and discharge.

As can be seen from Example 1, Comparative Example 1, and the evaluations of electrical storage devices in Example 2, the use of an oxide of cerium as the metal oxide in the anode 22 makes the electrical storage device of higher capacity than ones that incorporate an oxide of titanium. Furthermore, the simple structure makes the device capable of low-cost production and stable operation compared with lithium-ion batteries in which a liquid electrolyte is used.

TABLE 2

| | Temperature | Proton conductivity (S/cm) |
|---|---|---|
| Example 1 | 25° C. | 6.8 × 10⁻⁶ |
| Comparative Example 1 | 25° C. | 5.9 × 10⁻⁸ |

The present disclosure is not limited to the above embodiments and examples, and many variations and modifications are possible within the scope of the invention specified by the appended claims. For example, the technical features in the embodiments and examples corresponding to those in each form of the disclosure in DETAILED DESCRIPTION may be changed or combined as need to solve part or all of the aforementioned problems or to confer part or all of the aforementioned advantages. Furthermore, any technical feature may optionally be omitted unless it is described herein as being essential.

As is detailed hereinabove, the electrical storage device according to an aspect of the present disclosure provides a high-capacity electrical storage device that is simple in structure and therefore capable of low-cost production and stable operation, and the production method according to another aspect provides a method through which such an electrical storage device can be produced.

What is claimed is:

1. An electrical storage device comprising:
a conductive anode collector;
a conductive cathode collector;
an anode between the anode collector and the cathode collector, the anode containing a mixture of an insulating material and an oxide of cerium; and
a cathode between the cathode collector and the anode.

2. The electrical storage device according to claim 1, wherein:
the oxide of cerium is particles dispersed in the insulating material.

3. The electrical storage device according to claim 2, wherein the particles have an arithmetic mean particle diameter of 1 nm or more and 100 nm or less.

4. The electrical storage device according to claim 2, wherein the particles have an arithmetic mean particle diameter of 1 nm or more and 20 nm or less.

5. The electrical storage device according to claim 2, wherein the particles have an arithmetic mean particle diameter of 1 nm or more and 10 nm or less.

6. The electrical storage device according to claim 1, wherein the anode has a porous structure.

7. The electrical storage device according to claim 1, further comprising a solid electrolyte between the anode and the cathode.

8. The electrical storage device according to claim 1, wherein the anode collector or the cathode collector is made of at least one metal or an alloy as a combination of metals selected from the group consisting of copper, chromium, nickel, titanium, platinum, gold, aluminum, tungsten, iron, and molybdenum.

9. The electrical storage device according to claim 1, further comprising a substrate in contact with the anode collector on the side opposite the anode.

10. The electrical storage device according to claim 9, wherein the substrate is a flexible insulating sheet.

11. The electrical storage device according to claim 1, wherein the anode collector doubles as a substrate.

12. The electrical storage device according to claim 1, wherein the cathode is made of an oxide of nickel or a copper aluminum oxide.

13. The electrical storage device according to claim 1, wherein the insulating material includes at least one selected from the group consisting of silicone, silicon dioxide, magnesium oxide, alumina, and mineral oil.

14. The electrical storage device according to claim 13, wherein the insulating material is silicone.

15. The electrical storage device according to claim 1, wherein the insulating material includes at least one selected from the group consisting of thermoplastics including polyethylene, polypropylene, polystyrene, polybutadiene, polyvinyl chloride, polymethyl methacrylate, polyamide, polycarbonate, polyimide, and cellulose acetate, phenolic plastics, amino plastics, unsaturated polyester plastics, allyl plastics, alkyd plastics, epoxy plastics, and polyurethanes.

16. The electrical storage device according to claim 1, wherein the cathode is made of a p-type semiconductor material.

17. A method for producing an electrical storage device, the method comprising:
preparing an anode collector;
producing a coating liquid by dissolving particles of an oxide of cerium and an insulating material in an organic solvent;
applying the coating liquid to the anode collector to form a coating film;
firing the coating film to form an anode;
forming a cathode on the anode; and
forming a cathode collector on the cathode.

18. The method according to claim 17 for producing an electrical storage device, wherein the coating film is fired at a temperature not less than 200° C. and not more than 500° C. to form a dispersion of the particles of the oxide of cerium in the insulating material.

19. The method according to claim 17 for producing an electrical storage device, wherein the cathode is made of an oxide of nickel or a copper aluminum oxide.

20. The method according to claim 17 for producing an electrical storage device, wherein the cathode is made of a p-type semiconductor material.
